(19) United States
(12) Patent Application Publication
(10) Pub. No.: US 2007/0272169 A1
(43) Pub. Date: Nov. 29, 2007

(54) Drug Delivery Mask for Animals

(76) Inventors: Brian Barney, Essex (GB); Jane Hsiao, Weston, FL (US); Kenneth Kwochka, Miami Beach, FL (US); Siobhan D'Gama, London (GB)

Correspondence Address: GREENBERG TRAURIG, LLP, ONE INTERNATIONAL PLACE, 20th FL, ATTN: PATENT ADMINISTRATOR, BOSTON, MA, 02110, US

(21) Appl. No.: 10/572,250

(22) PCT Filed: Sep. 20, 2004
(86) PCT No.: PCT/US04/30823

§ 371 Date: Apr. 9, 2007

Related U.S. Application Data
(60) Provisional application No. 60/503,983, filed on Sep. 18, 2003.

(51) Int. Cl. A62B 18/02

(52) U.S. Cl. 119/831; 128/203.29

(57) ABSTRACT

A drug delivery mask for removable fixture to an animal includes an airborne medicament interface adapter adapted to couple to a medicament dispenser in a sealed manner, an animal interface adapter adapted to establish a substantial seal between the animal interface adapter and the animal, and a relatively flexible sleeve extending along a longitudinal axis between the medicament interface adapter and the animal interface adapter. The medicament interface adapter is coupled to the sleeve by a ball-and-socket coupler, which includes a hollow socket member contiguous with the sleeve, and a hollow ball member contiguous with the medicament interface adapter. The mask further includes a tubular element extends from an end of the hollow ball member opposite the medicament interface adapter. The sleeve of the mask further includes at least one annular relatively compliant seal member extending from an inner circumference of the sleeve.

### FIELD OF THE INVENTION

The invention relates to the delivery of drugs to animals, and more particularly to devices for enabling the delivery of drugs or medicaments to animals for pulmonary or nasal absorption via the mouth and or nose.

### BACKGROUND OF THE INVENTION

The deliver of a drug or a medicament to an animal, and in particular a mammal, such as a human, a dog or a horse, for pulmonary or nasal absorption is desired in many circumstances. Direct application, such as by a spray or aerosol delivery device, or a dry powder delivery device, is difficult due to movements of the animal. To enable such application of medicaments, in the prior art, an elongated, generally cup-shaped “mask” is often provided, having a relatively large open base end for fitment over an animal's nostril or muzzle and having a medicament administration port opposite that base end. Typically, the mask is made out of a semi-rigid material (e.g., sheet polycarbonate) and is provided in various sizes for use with different sized animals.

In use in the prior art, an appropriate sized mask is selected, and the open base end is positioned over the animal's nostril or muzzle, preferably with a friction fit at the open base end. The size of the open end is such that at least a rough seal is established between the open end of the mask and the animal's nostril or muzzle. When the mask is so positioned, medicament is delivered at the medicament administrative port, for example by spray, aerosol delivery device, or dry powder medicament delivery device, either breath-activated or user-driven. As the animal breathes, the medicament is drawn into one (or both) nostril(s), or in the mouth and into the lungs or the nasal passages.

However, when the animal breathes in the medicament through the mask, the animal's head may move in different directions, and because of the rigid connection between the medicament administration port of the mask and the medicament dispenser, the medicament administration port of the mask may come apart from the medicament dispenser, that, in turn, causes interruption or termination of the medicament supply to the animal. The interruption or termination of the medicament supply may cause serious damage to the animal's health.

Moreover, the semi-rigid structure of the prior art masks fail to provide a substantially seal between the interior region of the mask and the animal's face. That may cause insufficient or incorrect amount of medicament taken by the animal.

Therefore, there is a need for an improved mask for delivering drugs to animals for pulmonary or nasal absorption via the mouth and/or nose. Such improved mask should have flexible connection between the medicament administration port of the mask and the medicament dispenser, and have an improved seal manner between the mask and the animal.

### SUMMARY OF THE INVENTION

The present invention is a drug or medicament delivery device for fitting with the appropriate portion of the head of the animal such as the front of the head or over one nostril for the effective delivery of drugs or medicaments, for pulmonary or nasal absorption. The device is in the form of a mask. The mask includes an airborne medicament interface adapter adapted to couple to a medicament dispenser in a sealed manner, an animal interface adapter adapted to establish a substantial seal between the animal interface adapter and the animal, and a relatively flexible sleeve extending along a longitudinal axis between the medicament interface adapter and the animal interface adapter. The medicament interface adapter extends along a reference axis and is coupled to the sleeve with a ball-and-socket coupler.

The ball-and-socket coupler preferably includes a hollow socket member and a hollow ball member. The hollow socket member preferably includes a partially spherical inner surface characterized by radius R, defining an interior socket region disposed about and extending along the longitudinal axis from a distal end of the sleeve toward the medicament adapter. The socket member is contiguous with one of the medicament interface adapter and the sleeve, preferably the sleeve. The hollow ball member includes a partially spherical outer surface characterized by a radius equal to or slightly less than R. An inner surface of the hollow ball member defines an interior region extending along the reference axis of the medicament interface adapter from the medicament interface adapter toward the distal end of the sleeve. The ball member is contiguous with the other of the medicament interface adapter and the sleeve.

The partially spherical outer surface of the hollow ball member is captively held by the partially spherical inner surface of the hollow socket member, permitting relative movement of the ball member with respect to the socket member, whereby the reference axis of the medicament interface adapter may be selectively angularly offset or aligned with the longitudinal axis in response to relative motion of the ball member with respect to the socket member.

In a preferred form, the hollow socket member is contiguous with the sleeve and the hollow ball member is contiguous with the medicament interface adapter.

In yet another preferred embodiment, the ball member extends between two opposite ends, a first end from which medicament interface adapter extends, and a second end. An elongated tubular element extends along the reference axis from the second end of the ball member toward the animal interface adapter to an end disposed near the animal interface adapter. The medicament interface adapter, the hollow ball member, and the tubular element form a continuous inner passageway from a medicament interface defined by the medicament interface adapter to the end of the tubular element. The end of the tubular element is intended to be inserted into or against the animal's nostril or mouth, when the animal interface adapter is pressed against the animal's face, to further ensure that substantially all medication dispensed within the medicament interface adapter is delivered to the animal's nostril.

The tubular element preferably includes two sections, a first section coupled to the second end of the ball member, and a second section coupled to the first section. The medicament interface adapter, the ball member, and the first section of the tubular element are preferably manufactured integrally. The second section is preferably flexible, and most preferably, is bellows-shaped, such that the length of the tubular element and the direction of the end of the tubular element can be adjusted by compressing or expanding the bellows-shaped second section. The direction of the tubular element also can be adjusted by rotating the ball member with respect to the socket member. The tubular element preferably has a cylindrical shape, but alternative shapes, such as conical shapes, also can be used, and the diameter of the tubular element can vary along the length of the tubular element.

In a further preferred embodiment, the sleeve further comprises at least one annular relatively compliant seal member extending from an inner circumference of the sleeve. In one preferred form, the seal member is a toroidal tube, defining a closed interior region filled with gas. In another preferred form, the seal member is a sealing skirt made of relatively compliant material. The sealing skirt preferably extends toward the animal interface adapter. In use, when the animal interface adapter is pressed against the animal's face, the annular compliant seal member provides a further seal around the animal's nostril or muzzle.

The airborne medicament interface adapter is adapted to couple the sleeve to a medicament dispenser. Preferably, the medicament dispenser is breath-activated but may be user (e.g., care giver) actuated. The medicament dispenser may be in the form of a dry powder medicament dispenser, or in aerosol dispenser. Alternatively, a user-actuated spray dispenser may be used.

The animal interface adapter is adapted to provide a substantial (although not necessarily complete) pneumatic seal between the animal interface adapter and the appropriate portion of the head of the animal (e.g., the front of the head of a small child, the nostril or the muzzle of any animal such as cats, dogs or horses). By way of example, the animal interface adapter may be in the form of a thin or tapered flexible sheet, which when pressed against the area around the appropriate portion of the head, forms at least a rough seal. As a further example, the animal interface adapter may be in the form of a stretchable, nominally conic-frustum shaped elastic sheet, extending from a proximal end of the sleeve. In the elastic form, the sheet may be stretched as the largest ring is moved over the nostril or muzzle of the animal. In some forms, an elastic or otherwise adjustable strap extends from the animal interface adapter, where the strap may be placed around the back of an animal's head to secure the mask in place.

The sleeve, which extends between the medicament interface adapter and the animal interface adapter, preferably has a unitary bell shape structure and has a step-like lateral surface. In an alternative form, the sleeve has a straight conical lateral surface. The sleeve preferably has a cross section monotonically increasing between a relatively small distal end and a relatively large proximal end.

In one preferred embodiment of the present invention, the sleeve is a cone-like structure extending along the longitudinal axis between the animal interface adapter and the medicament interface adapter, and defining an interior region. The cone-like structure includes a set of rings having diameters, which monotonically decrease from the animal interface adapter to the medicament interface adapter, each of the rings including a flexible skirt extending therefrom, each skirt having a monotonically decreasing diameter. The sleeve may further include at least one relatively compliant seal member, each extending from an inner circumference of an associated one of the rings into the interior region. The sleeve may further include a plurality of radially distributed struts extending externally from the sleeve and coupling at least one ring to the skirt of the next larger ring.

In another preferred embodiment, the mask is collapsible to permit use in a full or partially open state, and to permit easy and convenient transport in a collapsed or closed state. In a collapsed condition, a relatively small ring of the sleeve is fitted or nested into the next relatively large ring. In a preferred form, the mask of the invention is particularly adaptable to accommodate size variation in animals.

The present invention is intended for use with any animal, which may experience the benefits of the invention. Foremost among such animals are those, which are difficult to control or cannot be made to cooperate in the delivery of drugs or medicaments via conventional delivery devices. Hence, the term “animal” is used to designate patients such as infants, children, physically or mentally disabled patients, as well as any other animal (e.g., a dog, a cat or a horse).

### BRIEF DESCRIPTION OF THE DRAWINGS

For a fuller understanding of the nature and the objects of the invention, reference should be made to the following detailed description and the accompanying drawings in which the reference numerals refer to like elements and in which:

FIG. 1 shows a perspective view of a drug delivery mask in accordance with one preferred embodiment of the present invention;

FIG. 2 shows a cross-sectional view of the drug delivery mask in FIG. 1, taken along the axis A;

FIG. 3 shows a side view of a drug delivery mask in accordance with another preferred embodiment of the present invention;

FIG. 4A shows an exploded view of a ball-and-socket coupler in accordance with one preferred embodiment of the present invention;

FIG. 4B shows an exploded view of a ball-and-socket coupler in accordance with another preferred embodiment of the present invention;

FIG. 5 shows a cross-sectional view of a drug delivery mask in accordance with another preferred embodiment of the present invention, taken along the central axis A;

FIG. 6 shows a perspective view of a drug delivery mask, showing the mask in a collapsed condition, in accordance with another preferred embodiment of the present invention;

FIG. 7 shows a cross-sectional view of a drug delivery mask in accordance with one preferred embodiment of the present invention, taken along the central axis A;

FIG. 8 shows a cross-sectional view of a drug delivery mask in accordance with another preferred embodiment of the present invention, taken along the central axis A;

FIG. 9 shows a cross-sectional view of a drug delivery mask in accordance with a further preferred embodiment of the present invention, taken along the central axis A;

FIG. 10 shows a perspective view of a drug delivery mask in accordance with yet another preferred embodiment of the present invention;

FIG. 11 shows a cross-sectional view of the drug delivery mask in FIG. 10, taken along the axis A; and

FIG. 12 shows a cross-sectional view of a drug delivery mask in accordance with another preferred embodiment of the present invention, taken along the central axis A;

### DETAILED DESCRIPTION OF THE PREFERRED EMBODIMENTS

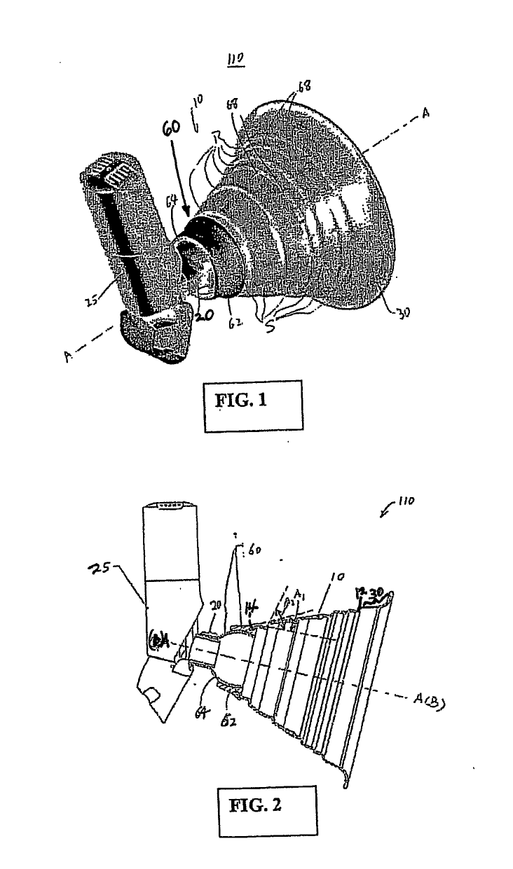

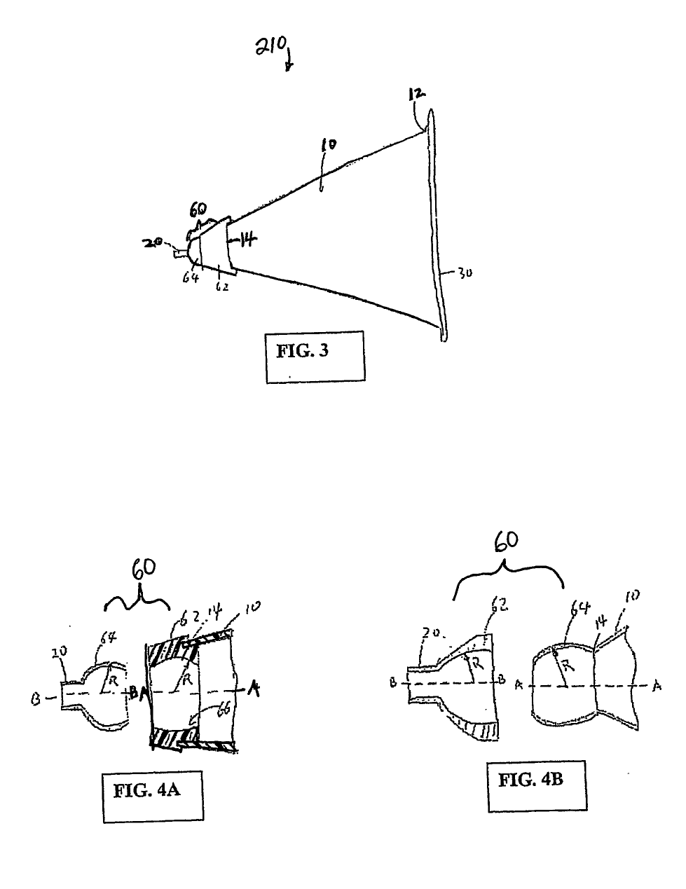

An exemplary drug delivery mask 110 embodying the present invention for use with dogs, horses, humans and other mammals is shown in FIG. 1. FIG. 2 shows a cross-sectional view of the mask 110 in FIG. 1. The mask 110 includes a sleeve 10 extending along a longitudinal axis A between a relatively large proximal end 12 and a relatively small distal end 14. In one preferred embodiment, the sleeve 10 has a unitary bell shape structure and has a step-like lateral surface. In an alternative form, the sleeve 10 has a straight conical lateral surface, as shown in FIG. 3. The sleeve 10 preferably has a cross section monotonically increasing between the relatively small distal end 14 and the relatively large proximal end 12.

An animal interface adapter 30 is formed at the relatively large proximal end 12. An airborne medicament interface adapter 20 extending along a reference axis B is coupled to the relatively small distal end 14 by a ball-and-socket coupler 60, which includes a hollow socket member 62 and a hollow ball member 64. In FIG. 2, the reference axis B is aligned with the longitudinal axis A of the sleeve.

FIG. 4A shows an exploded cross-sectional view of the socket-and-ball coupler 60. The hollow socket member 62 preferably includes a partially spherical inner surface characterized by radius R, defining an interior socket region 66 disposed about and extending along the longitudinal axis A from the distal end 14 of the sleeve 10 toward the medicament interface adapter 20. The socket member 62 is preferably contiguous with the sleeve 10.

The hollow ball member 64 includes a partially spherical outer surface characterized by a radius equal to or slightly less than R. An inner surface of the hollow ball member 64 defines an interior region extending along the axis B from the medicament interface adapter 20 toward the distal end 14 of the sleeve 10. The ball member 64 is preferably contiguous with the medicament interface adapter 20.

The partially spherical outer surface of the hollow ball member 64 is captively held by the partially spherical inner surface of the hollow socket member 62, permitting relative movement of the ball member 64 with respect to the socket member 62, whereby the axis B of the medicament interface adapter may be selectively angularly offset or aligned with the longitudinal axis A, along which the socket 62 and the sleeve 10 extend, in response to relative motion of the ball member 64 with respect to the socket member 62. The partially spherical outer surface of the ball member 64 is preferably frictionally coupled to the partially spherical inner surface of the socket member 62, such that the relative orientation of the ball member 64 and the socket member 62 is maintained constant until a relative force is applied between the ball member 64 and the socket member 62 above a predetermined threshold force F. One of, or both of the partially spherical outer surface of the ball member 64 and the partially spherical inner surface of the socket member 62 have a frictional texture to effect the frictional coupling between the two surfaces.

In an alternative form as shown in FIG. 4B, the hollow socket member 62 is contiguous with the medicament interface adapter 20 and extends along the axis B, and the hollow ball member 64 is contiguous with the sleeve 10 and extends along the axis A.

The medicament interface adapter 20 is shaped to couple to, or receive, an external aerosolizing medicament dispenser 25. In FIGS. 1 and 2, the dispenser 25 is schematically represented as an aerosol dispenser. In various embodiments, the dispenser 25 may be a metered dose breath-actuated or user- (e.g., veterinarian) operated inhaler and may be a dry powder or aerosol dispenser. Preferably, the device 25 includes an output structure which directs airborne medicaments to the interior of the medicament interface adapter 20. The medicament interface adapter 20 can be manufactured with different size and shapes to match the mouthpiece of different medicament dispensers.

The device 25 may be used for any drug formulation which may be advantageously administered to the lung or nasal passages in an animal, to cure or alleviate any illness or its symptoms. Many medicaments, bioactive active substances and pharmaceutical compositions may be included in the dosage forms of the present invention. Non-limiting examples of classes of drugs contemplated for use include ace-inhibitors, acne drugs, alkaloids, amino acid preparations, anabolic preparations, analgesics, anesthetics, antacids, antianginal drugs, anti-anxiety agents, anti-arrhythmias, anti-asthmatics, antibiotics, anti-cholesterolemics, anti-coagulants, anti-convulsants, anti-depressants, anti-diabetic agents, anti-diarrhea preparations, antidotes, anti-emetics, anti-histamines, anti-hypertensive drugs, anti-inflammatory agents, anti-lipid agents, anti-manics, anti-nauseants, anti-nauseants, anti-neoplastics, anti-obesity drugs, anti-parkinsonism agents, anti-psychotics, anti-pyretics, anti-rheumatic agents, anti-spasmodics, anti-stroke agents, anti-thrombotic drugs, anti-thyroid preparations, anti-tumor drugs, anti-tussives, anti-ulcer agents, anti-uricemic drugs, anti-viral drugs, appetite stimulants or suppressants, biological response modifiers, blood modifiers, bone metabolism regulators, cardiovascular agents, central nervous system stimulates, cerebral dilators, cholinesterase inhibitors, contraceptives, coronary dilators, cough suppressants, decongestants, dietary supplements, diuretics, DNA and genetic modifying drugs, dopamine receptor agonists, endometriosis management agents, enzymes, erectile dysfunction therapies, erythropoietic drugs, expectorants, fertility agents, gastrointestinal agents, homeopathic remedies, hormones, hyper- and hypo-glycemic agents, hypercalcemia and hypocalcemia management agents, hypnotics, immunomodulators, immunosuppressives, ion exchange resins, laxatives, migraine preparations, motion sickness treatments, mucolytics, muscle relaxants, neuromuscular drugs, obesity management agents, osteoporosis preparations, oxytocics, parasympatholytics, parasympathomimetics, peripheral vasodilators, prostaglandins, psychotherapeutic agents, psycho-tropics, stimulants, respiratory agents, sedatives, smoking cessation aids, sympatholytics, systemic and non-systemic anti-infective agents, terine relaxants, thyroid and anti-thyroid preparations, tranquilizers, tremor preparations, urinary tract agents, vasoconstrictors, vasodilators, and combinations thereof.

In some embodiments of the invention, the dosage form for use with the invention comprises anti-inflammatory agents suitable for inhalation administration. Such anti-inflammatory agent may include, for example, bronchodilators and steroids. Representative β₂-adrenergic receptor agonist bronchodilators include, without limitation, salmeterol, formoterol, bambuterol, albuterol, terbutaline, pirbuterol, bitolterol, metaproterenol, isoetharine, isoproterenol, fenoterol, or procaterol. Non-limiting anti-inflammatory steroids contemplated for use with the invention include budesonide, beclomethasone, fluticasone, and triamcinolone diacetate. Additional anti-inflammatory agents contemplated include ipatropium bromide and sodium cromoglycate.

Therapeutically effective formulations and dosages to be administered using the devices described herein are well known to practitioners. One of skill in the art will appreciate that practitioners may opt to alter dosages and/or formulations to fit a particular patient/animal needs.

The animal interface adapter 30 extends along axis A from the relatively large proximal end 12 of the sleeve 10. The animal interface adapter 30 is preferably manufactured integrally with the sleeve 10, as shown in FIGS. 1-3. The animal interface adapter 30 is preferably in the form of a tapered sheet 32. In other embodiments, the sheet 32 can be in the form of a conic-frustum shaped shroud made of an easily stretchable elastic material. The sheet 32 is adapted to provide a substantial (although not necessarily total) pneumatic seal between sleeve 10 and the nostril or muzzle of an animal. The animal interface adapter 30 may optionally include a stretchable elastic or otherwise adjustable strap extending from the proximal end 12 of the sleeve, to permit secure fixture of mask 110 to the head of the animal.

Referring to FIG. 1, in one preferred embodiment, the sleeve 10 has a cone-like structure, and includes a set of rings R having diameters which monotonically decrease from the animal interface adapter 30 to the medicament interface adapter 20, each of the rings including a monotonically decreasing diameter flexible skirt S extending therefrom. The skirts are nominally conic shells having a sidewall slope characterized by an angle A1 with respect to the longitudinal axis A (as shown in FIG. 2). The angle A1 is greater than zero and less than ninety degrees. The rings R are nominally conic structures having a sidewall slope characterized by an angle A2 with respect to the longitudinal axis A. The angle A2 is preferably greater than A1 and less than or equal to ninety degrees. In one preferred embodiment, the sleeve 10 further comprises along at least one of the rings R, a plurality of radially distributed struts 68 extending externally from the sleeve 10 and coupling at least one ring to the skirt of the next larger ring.

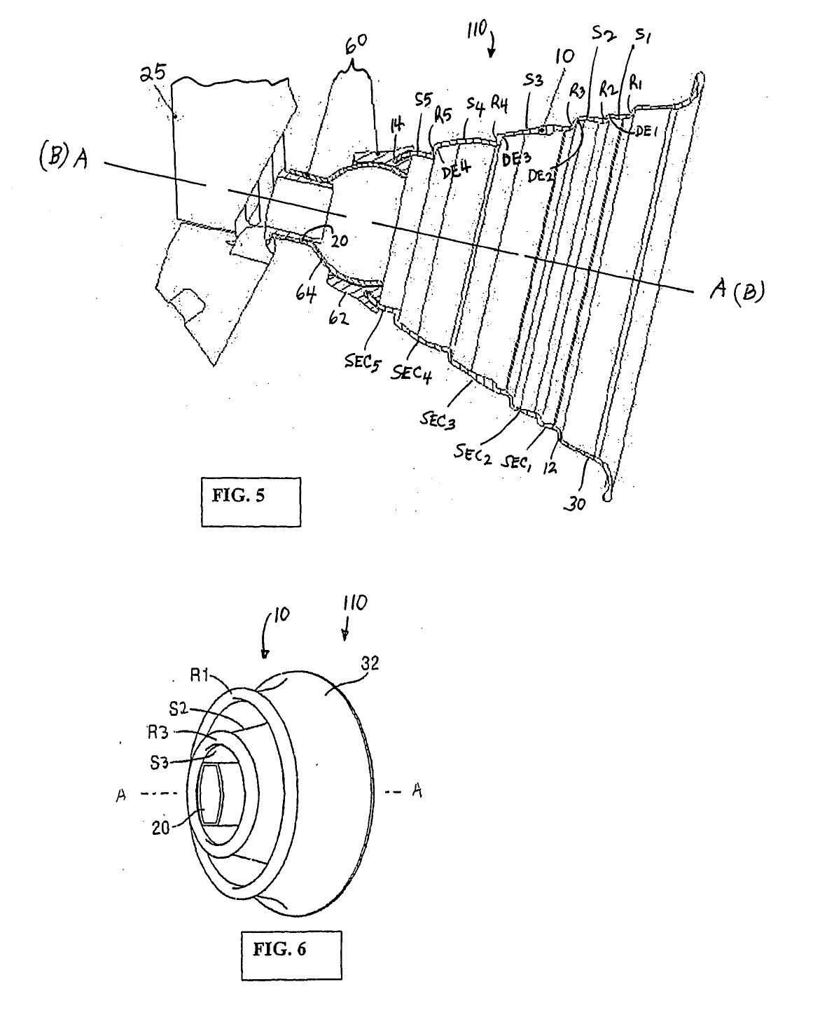

In one preferred embodiment, as shown in FIG. 5, the sleeve 10 includes four sections SEC1, SEC2, SEC3, and SEC4 extending along the central axis A. Each of the sections includes a relatively inflexible ring Ri defining an associated first contour, having a relatively flexible skirt Si extending therefrom to a distal edge DEi. The distal edge DEi defines a second contour, where “i”=1, 2, 3, . . . . The rings R1, R2, R3, R4 of assemblies SEC1, SEC2, SEC3, and SEC4 form a monotonically decreasing succession of circular rings, from the largest ring R1 to the smallest ring R4. The succession is monotonic such that the individual rings in the succession are successively smaller, although in other embodiments, a ring may be the same (but not larger than) its next (in the succession) neighbor. Moreover, as shown, each ring in the illustrated embodiment is sufficiently larger than the next ring (in the succession) so that the smaller ring fits, i.e., nests, within its larger neighbor. The distal edge DEi of each ring Ri is the same size as the contour defined by next smaller ring R in the succession; that is, DE1 is the same size as R2, DE2 is the same size as R3 and DE3 is the same size as R4. The distal edge DEi of each skirt of sections SEC1, SEC2, and SEC3 is joined to the ring of the respective one of neighboring sections SEC2, SEC3, and SEC4. The distal edge DE4 is joined to the hollow socket member 62.

In one preferred form, the sleeve 10 is fully collapsible and can be folded into a relatively small volume, as shown in FIG. 6. In other alternative forms, the sleeve 10 may be partially collapsible or non-collapsible. In a collapsed condition, the relatively small ring of the sleeve fits or nests into the next relatively large ring. Different types of sleeves, which can be used with the present invention, are disclosed in U.S. Pat. No. 6,510,818 and U.S. Patent Publication No. 2003/0070626, which are incorporated herein by reference.

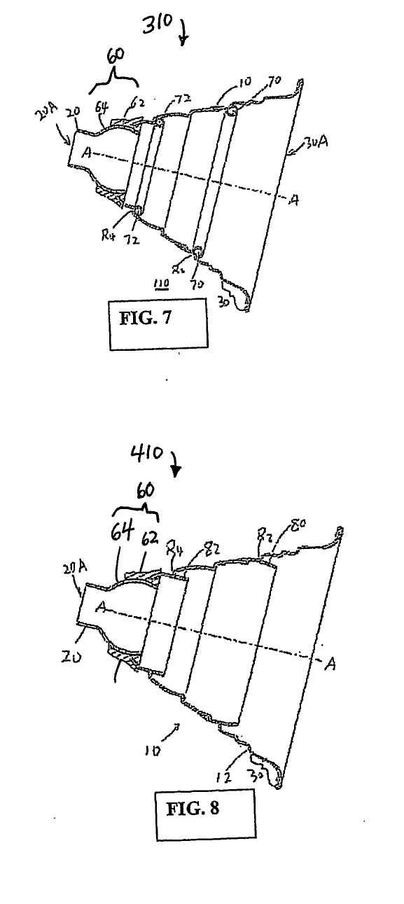

The sleeve 10 of the mask 110 may further includes at least one annular-shaped relatively compliant seal member extending from an inner circumference of the sleeve 10. FIG. 7 illustrates a preferred embodiment, in which the sleeve 10 further includes compliant sealing members, which are two toroidal tubes or rings 70 and 72, one extending from the second ring R2 and the other extending from the forth ring R4. The toroidal tubes 70 and 72 are preferably made of a flexible material and each form an inner channel filled with gas, so that the toroidal tubes 70 and 72 are elastic and are adapted to provide substantial pneumatic seals between the associated rings and the face of the animal. The gas filled inner channel may have a pressure equal to, less than, or greater than atmosphere. In an alternative form, the gas filled channel is pneumatically coupled to the atmosphere. In other alternative forms, the mask 110 may include only one toroidal tube, or more than two toroidal tubes, and the toroidal tubes may extend from any of the section rings R of the sleeve 10.

In another alternative form, as shown in FIG. 8, the mask 110 includes annular sealing webs or skirts 80 and 82 instead of toroidal tubes. The sealing skirts 80 and 82 extend from the rings R2 and R4 toward the proximal end 12 of the sleeve 10. The sealing skirts 80 and 82 are preferably made of flexible material and are adapted to provide substantial pneumatic seals between the associated rings and the face of the animal. FIG. 9 shows a preferred embodiment, in which a sealing skirt 84 extends from the tapered sheet 32 of the animal interface adapter 30, and another sealing skirt 86 extends from the second ring R2. In use, the skirts help to direct the medication to the animal's nostril or mouth, and also provide a further relatively small sealing circumference around the animal's nostril or mouth.

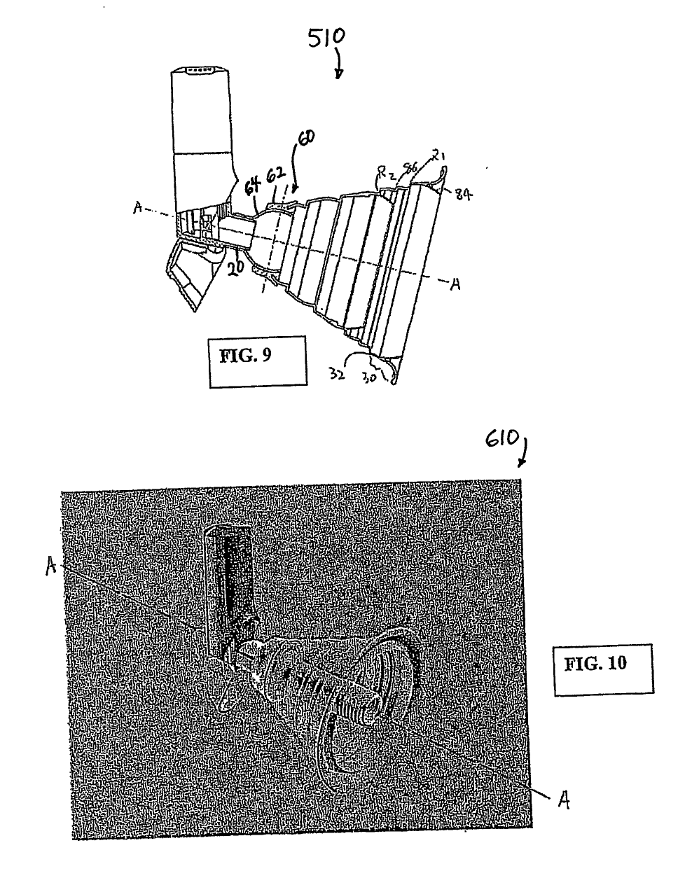

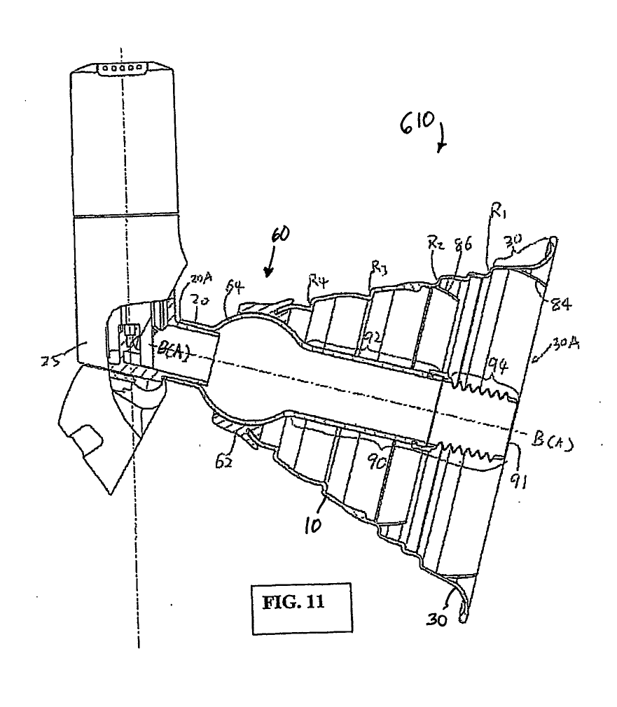

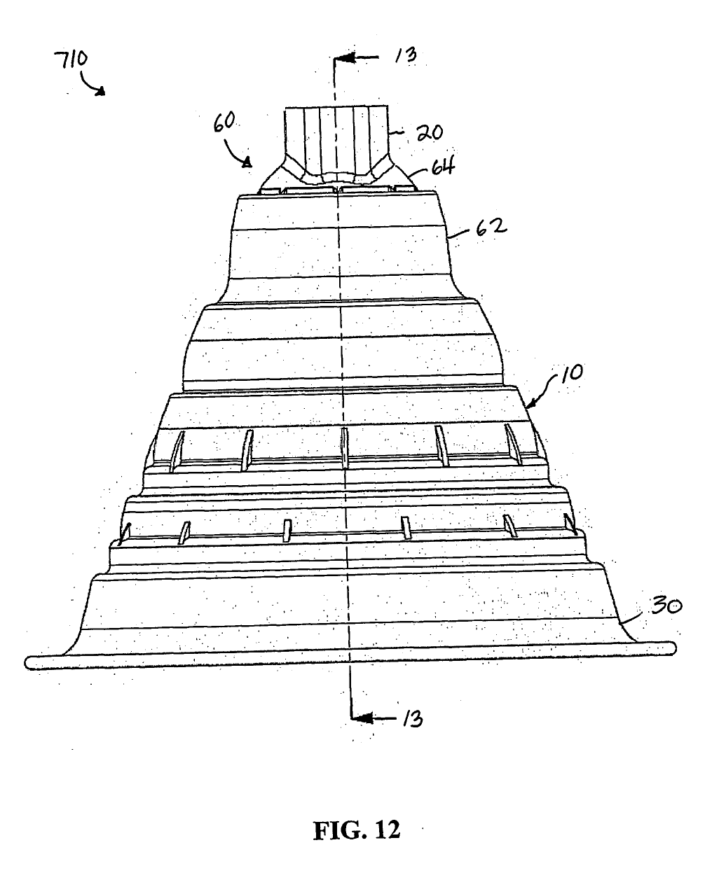

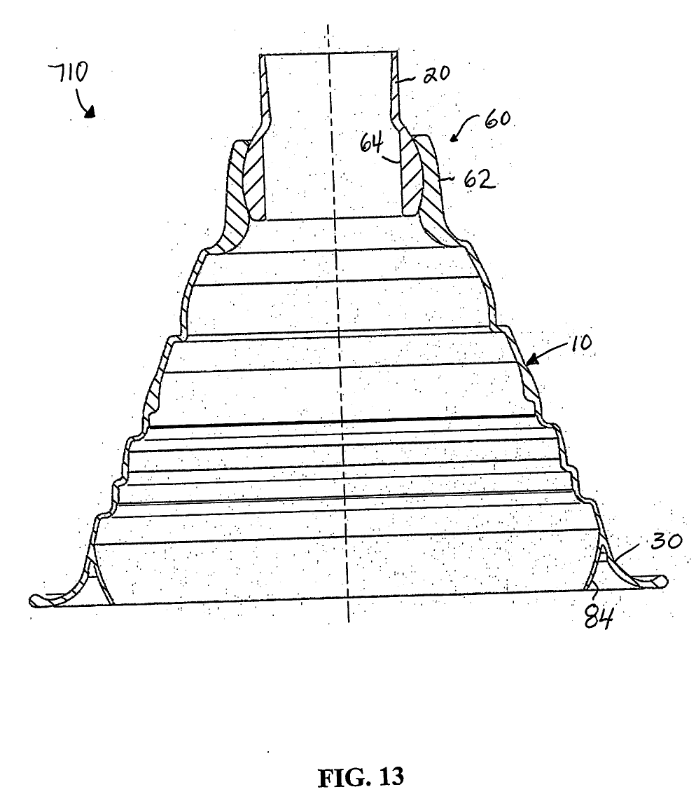

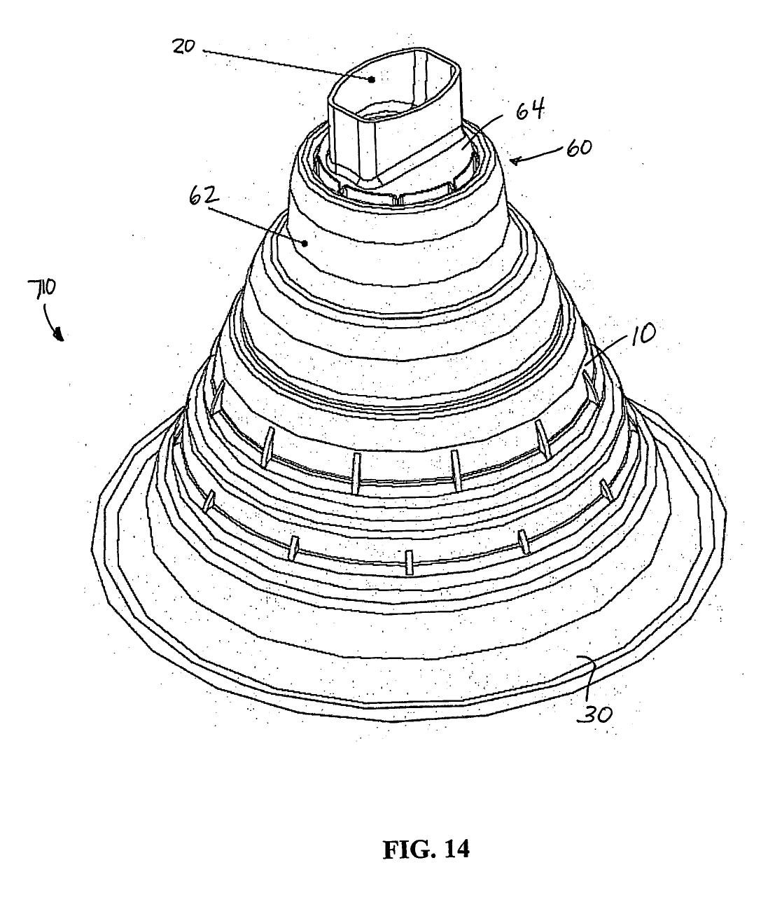

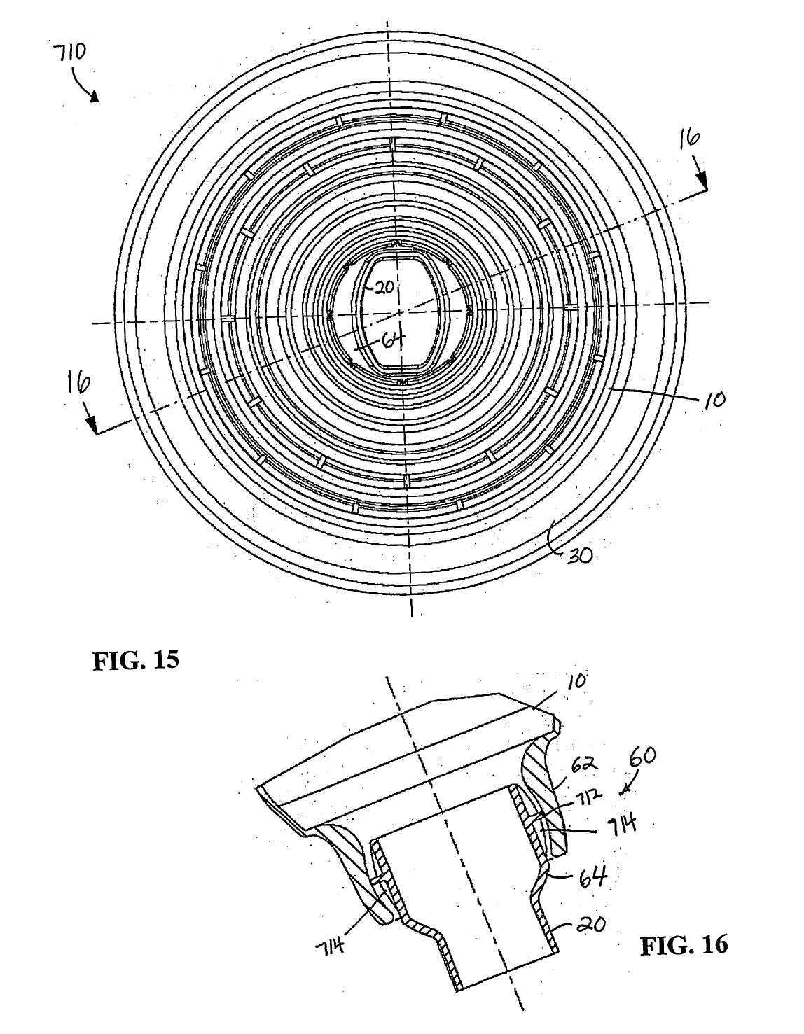

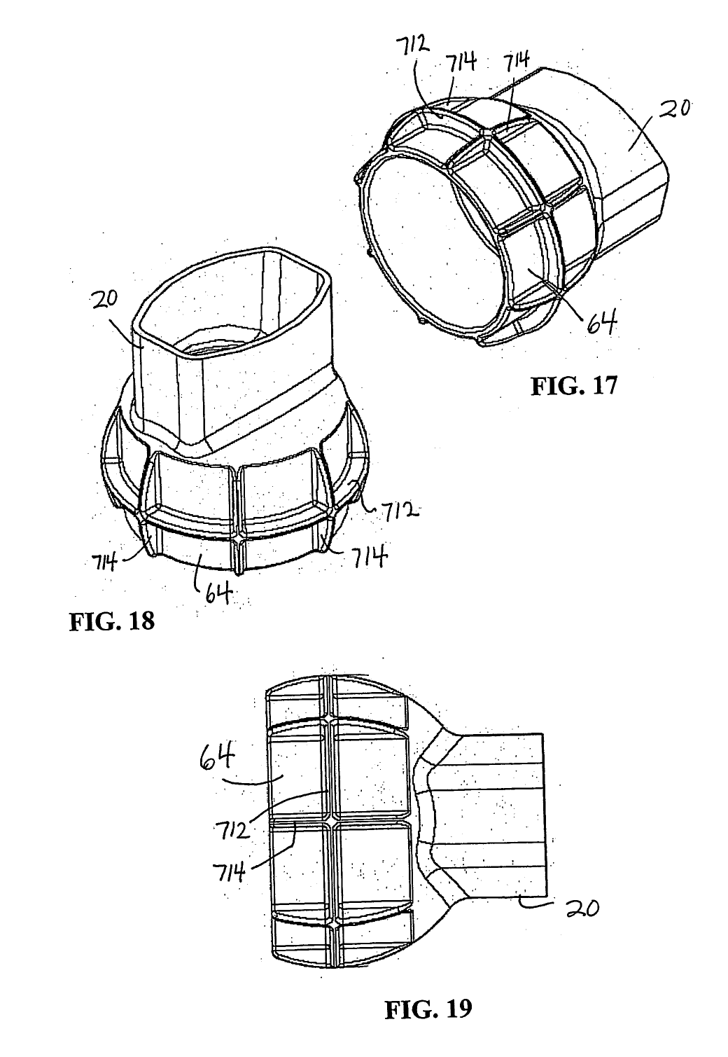

FIG. 10 illustrates a perspective view of another preferred embodiment of the present invention. FIG. 11 illustrates a cross-sectional view of the mask 110 in FIG. 10. In FIGS. 10-12, the mask 110 further comprises an elongated tubular element 90 extending, along the reference axis B, from an end of the hollow ball member 64 opposite the medicament interface adapter 20 toward the animal interface adapter 30 to an end 91 near the animal interface adapter 30. The elongated tubular element 90 preferably includes two sections 92 and 94. The first section 92 is preferably manufactured integrally with the hollow ball member 64. The second section 94 is connected to the first section 92, and preferably has a bellows shape. The medicament interface adapter 20, the hollow ball member 64, and the tubular element 90 form a continuous inner passageway extending from an medicament interface 20A defined by the medicament interface adapter 20 to the end 91 of the tubular element 90. The end 91 of the elongated tubular element 90 is intended to be inserted into or against an animal's nostril or mouth when the animal interface adapter 30 is pressed against the animal's face, to further ensure that substantially all medication dispensed within the medicament interface adapter 20 is delivered to the animal's nostril or mouth. Because the second section 94 is bellows-shaped, the length of the tubular element 90 and the direction of the end 91 can be adjusted by compressing or expanding the bellows to direct the end 91 to the animal's nostril or mouth. Further more, in use, the ball member 64 can be rotated by an administrator or by the movement of the animal's head with respect to the socket member 62 to angularly offset or align the axis B of the medicament interface adapter 20 with the axis A of the sleeve, and to adjust the direction of the end 91 to fit into the animal's nostril or mouth. The ball-and-socket coupler 60 further prevents the medicament interface adapter 20 from coming apart from the medicament dispenser 25, caused by the movement of the animal's head. In FIGS. 11 and 12, the reference axis B is aligned with the longitudinal axis A of the sleeve 10.

The tubular element 90 also can be manufactured with different original length to use with different animals. In the embodiment shown in FIG. 11, the elongated tubular element 90 extends a distance such that the end 91 is placed in the interface plane 30A defined by the boundary of the animal interface adapter 30. In an alternative embodiment, as shown in FIG. 12, the elongated tubular element 90 is relatively short, and the end 91 is placed within the sleeve 90. The tubular element 90 preferably has a cylindrical shape, but alternative shapes, such as conical shapes, also can be used, and the diameter of the tubular element can vary along the length of the tubular element, for example, increasing first and then decreasing.

As shown in FIGS. 11 and 12, the sealing webs 84 and 86, which extend from the tapered sheet 32 and the second ring R2, further help to seal the interface between the sleeve 10 and the animal face, and to ensure that medication is delivered to the animal's nostril or mouth.

In general, the sleeve 10 and the animal interface adapter 30 are preferably made from a soft, supple material having good memory. By way of example, the sleeve 10 and the animal interface adapter 30 are made from plastics, for example, one of the group consisting of thermoplastic elastomers, high density polyethylene, low density polyethylene, polypropylene, and silicone rubber. By way of example, the thermoplastic may be of the type sold under the trademarks Elastolene, Evoprene, Pebax or Santoprene. With such materials, the mask is easily washable for use with a number of animals in kennels or stables, with no risk of cross-contamination. It is also envisioned that the mask can be made from materials other than plastic, such as a rubber, synthetic rubber, silicone, soft nylons, or can include support materials, such as fibers or a cloth material, such as canvas, contained within the plastic or rubber to provided strength and durability.

The hollow socket member 62 and the hollow ball member 64 are preferably made from a rigid material, or at least the outer surface of the ball member 64 and the inner surface of the socket member 62 are rigid, allowing relative rotary movement of the ball member 64 with respect to the socket member 62. The medicament interface adapter 20 and the first section 92 of the elongated tubular element 90 are preferably made from rigid material and are manufactured integrally with the hollow ball member 64. The second bellows-shaped section 94 is preferably made from a semi-rigid or flexible material.

While the claimed invention has been described in detail and with reference to specific embodiments thereof, it will be apparent to one of ordinary skill in the art that various changes and modifications can be made to the claimed invention without departing from the spirit and scope thereof. Thus, for example those skilled in the art will recognize, or be able to ascertain, using no more than routine experimentation, numerous equivalents to the specific substances and procedures described herein. Such equivalents are considered to be within the scope of this invention, and are covered by the following claims.

What is claimed is:

1. A drug delivery device for removable fixture to an animal, comprising:
A. an airborne medicament interface adapter adapted to couple to a medicament dispenser in a sealed manner, said medicament interface adapter extending along a reference axis;
B. an animal interface adapter adapted to establish a substantial seal between the animal interface adapter and the animal; and
C. a relatively flexible sleeve extending along a longitudinal axis between the medicament interface adapter and the animal interface adapter,
wherein the medicament interface adapter is coupled to the sleeve with a ball-and-socket coupler.

2. The drug delivery device of claim 1, wherein said ball-and-socket coupler comprises:
A. a hollow socket member, said socket member having a partially spherical inner surface characterized by radius R, defining an interior socket region disposed about and extending along said longitudinal axis from a distal end of said sleeve toward said medicament interface adapter, said socket member being contiguous with one of said medicament interface adapter and said sleeve;
B. a hollow ball member, said ball member having a partially spherical outer surface characterized by a radius equal to or slightly less than R and having an inner surface defining an interior region extending along said reference axis of said medicament interface adapter from said medicament interface adapter toward said distal end of said sleeve, said ball member being contiguous with the other of said medicament interface adapter and said sleeve,
wherein said partially spherical outer surface of said ball member is captively held by said partially spherical inner surface of said socket member, permitting relative movement of said ball member with respect to said socket member, whereby said reference axis of said medicament interface adapter may be selectively angularly offset or aligned with said longitudinal axis in response to relative movement of said ball member with respect to said socket member.

3. The drug delivery device of claim 1, wherein said ball member is contiguous with said medicament interface adapter and said socket member is contiguous with said sleeve.

4. The drug delivery device of claim 1, wherein said ball member is contiguous with said sleeve and said socket member is contiguous with said medicament interface adapter.

5. The drug delivery device of claim 1, wherein said partially spherical outer surface of said ball member is frictionally coupled to said partially spherical inner surface of said socket member, whereby the relative orientation of said ball member and said socket member is maintained constant until a relative force is applied between said ball member and said socket member above a predetermined threshold force F.

6. The drug delivery device of claim 5, wherein said frictional coupling is effected in part due to one or both of said spherical surfaces having a predetermined texture.

7. The drug delivery device of claim 1, wherein said ball member and said socket member are substantially rigid in the neighborhood of said partially spherical surfaces.

8. The drug delivery device of claim 1 further comprising a medicament dispenser coupled to said medicament interface adapter, said medicament dispenser characterized by an interior reservoir adapted to receive medicament, and having a dispensing port coupled to said reservoir and directed to said medicament interface adapter.

9. The drug delivery device of claim 8, wherein said dispenser is breath-actuated.

10. The drug delivery device of claim 1, wherein said sleeve has a cross section monotonically increasing between the medicament interface adapter and the animal interface adapter.

11. The drug delivery device of claim 1, wherein said sleeve further comprises at least one annular relatively compliant seal member extending from an inner circumference of said sleeve.

12. The drug delivery device of claim 11, wherein said seal member is a toroidal tube, defining a closed interior region filled with gas.

13. The drug delivery device of claim 11, wherein said seal member is a sealing skirt made of relatively compliant material.

14. The drug delivery device of claim 2, wherein said ball member includes two opposite ends, a first end coupled to said medicament interface adapter, and a second end, wherein said drug delivery device further comprises a tubular element extending along the reference axis of said medicament interface adapter from a first end, which is coupled to said second end of said ball member, to a second end near said animal interface adapter, wherein said medicament interface adapter, said ball member, and said tubular element form a continuous inner passageway from a medicament interface defined by said medicament interface adapter to the second end of said tubular element.

15. The drug delivery device of claim 14, wherein said tubular element includes a first section contiguous with said ball member, and a second section connected to said first section, wherein said second section is flexible.

16. The drug delivery device of claim 15, wherein said second section is bellows-shaped.

17. The drug delivery device of claim 14, wherein said tubular element characterized by a length, such that said second end of said tubular element is disposed close to or in an interface plane defined by said animal interface adapter.

18. The drug delivery device of claim 14, wherein said tubular element characterized by a length, such that said second end of said tubular element is disposed within said sleeve.

19. A drug delivery device for removable fixture to an animal, comprising:
A. an airborne medicament interface adapter adapted to couple to a medicament dispenser in a sealed manner;
B. an animal interface adapter adapted to establish a substantial seal between the animal interface adapter and the animal; and
C. a relatively flexible sleeve extending along a longitudinal axis between the medicament interface adapter and the animal interface adapter,
wherein said sleeve is a cone-like structure extending along said longitudinal axis between said animal interface adapter and said medicament interface adapter, and defining an interior region, said structure including a set of rings having diameters which monotonically decrease from said animal interface adapter to said medicament interface adapter, each of said rings including a flexible skirt extending therefrom, each skirt having a monotonically decreasing diameter, and
further including at least one relatively compliant seal member extending from an associated one of said rings into said interior region.

20. The drug delivery device of claim 19, wherein said seal member is a toroidal tube made of a relatively compliant material

21. The drug delivery device of claim 20, wherein said toroidal tube is hollow, and defines an interior region.

22. The drug delivery device of claim 21, wherein said interior region is closed.

23. The drug delivery device of claim 22, wherein said closed interior region is gas filled.

24. The drug delivery device of claim 23, wherein said gas-filled interior region is at a pressure greater than atmosphere.

25. The drug delivery device of claim 23, wherein said gas-filled interior region is at a pressure less than atmosphere.

26. The drug delivery device of claim 23, wherein said gas-filled interior region is at a pressure equal to atmosphere.

27. The drug delivery device of claim 21, wherein said interior region is pneumatically coupled to atmosphere.

28. The drug delivery device of claim 19, wherein said seal member is a sealing skirt made of relatively compliant material.

29. The drug delivery device of claim 19, further comprising a medicament dispenser coupled to said medicament interface adapter, said medicament dispenser characterized by an interior reservoir adapted to receive medicament, and having a dispensing port coupled to said reservoir and directed to said medicament interface adapter.

30. The drug delivery device of claim 29, wherein said dispenser is breath-actuated.

31. The drug delivery device of claim 19, wherein the medicament interface adapter is coupled to the sleeve with a ball-and-socket coupler.

32. The drug delivery device of claim 31, wherein said ball-and-socket coupler comprises:
A. a hollow socket member, said socket member having a partially spherical inner surface characterized by radius R, defining an interior socket region disposed about and extending along said longitudinal axis from a distal end of said sleeve toward said medicament interface adapter, said socket member being contiguous with one of said medicament interface adapter and said sleeve;
B. a hollow ball member, said ball member having a partially spherical outer surface characterized by a radius equal to or slightly less than R and having an inner surface defining an interior region extending along said reference axis of said medicament interface adapter from said medicament interface adapter toward said distal end of said sleeve, said ball member being contiguous with the other of said medicament interface adapter and said sleeve,
wherein said partially spherical outer surface of said ball member is captively held by said partially spherical inner surface of said socket member, permitting relative movement of said ball member with respect to said socket member, whereby a reference axis, along which said medicament interface adapter extends, may be selectively angularly offset or aligned with said longitudinal axis in response to relative movement of said ball member with respect to said socket member.

33. The drug delivery device of claim 32, wherein said ball member includes two opposite ends, a first end coupled to said medicament interface adapter, and a second end, wherein said drug delivery device further comprises a tubular element extending along the reference axis of said medicament interface adapter from a first end, which is coupled to said second end of said ball member, to a second end near said animal interface adapter, wherein said medicament interface adapter, said ball member, and said tubular element form a continuous inner passageway from a medicament interface defined by said medicament interface adapter to the second end of said tubular element.

34. The drug delivery device of claim 33, wherein said tubular element includes a first section contiguous with said ball member, and a second section connected to said first section, wherein said second section is flexible.

35. The drug delivery device of claim 34, wherein said second section is bellows-shaped.

36. A drug delivery device for removable fixture to an animal, comprising:
A. a relatively flexible sleeve extending along a longitudinal axis between a relatively large proximal end and a relatively small distal end, wherein said sleeve forms an animal interface adapter at said proximal end, said animal interface adapter being adapted to establish a substantial seal between said sleeve and the animal;
B. a hollow socket member attached to said distal end of said sleeve, said socket member having a partially spherical inner surface characterized by radius R; and
C. a hollow ball member extending along a reference axis between two opposite ends, a first end and a second end, said ball member having a partially spherical outer surface characterized by a radius equal to or slightly less than R and having an inner surface defining an interior region extending along said reference axis between said two opposite ends,
wherein said partially spherical outer surface of said ball member is captively held by said partially spherical inner surface of said socket member, permitting relative movement of said ball member with respect to said socket member, whereby said reference axis of said ball member may be selectively angularly offset or aligned with said longitudinal axis of said sleeve in response to relative movement of said ball member with respect to said socket member,
and wherein a first tubular element extends from said first end of said ball member in a direction away from said sleeve, said first tubular element form a medicament interface adapter, which is adapted to couple to a medicament dispenser in a sealed manner,
and wherein a second tubular element extends from said second end of said
ball member toward said animal interface adapter to an end near said animal interface adapter.

37. The drug delivery device of claim 36, wherein said second tubular element includes two section, a first section coupled to said second end of said ball member, and a second section coupled to said first section, wherein said second section is flexible.

38. The drug delivery device of claim 37, wherein said second section of said second tubular element is substantially bellows-shaped.

39. The drug delivery device of claim 36, wherein said sleeve further comprises at least one annular relatively compliant seal member extending from an inner circumference of said sleeve.

40. A drug delivery device for removable fixture to an animal, comprising:
a cone-like structure extending along a longitudinal axis between an animal interface adapter and a medicament interface adapter, and defining an interior region, said structure including a set of rings having diameters which monotonically decrease from said animal interface adapter to said medicament interface adapter, each of said rings including a monotonically decreasing diameter flexible skirt extending therefrom,
wherein, said skirts are nominally conic shells having a sidewall slope characterized by an angle A1 respect to said longitudinal axis, wherein A1 is greater than zero and less than ninety degrees, and
wherein, said rings are nominally comic structures having a sidewall slope characterized by an angle A2 with respect to said longitudinal axis, wherein A2 is greater than A1 and less than or equal to ninety degrees, and
further comprising along at least one of said rings, a plurality of radially distributed struts extending externally from said mask and coupling said at least one ring to the skirt of the next larger ring.

41. The drug delivery device of claim 40, wherein the medicament interface adapter is coupled to the sleeve with a ball-and-socket coupler.

42. The drug delivery device of claim 41, wherein the ball-and-socket coupler comprises a hollow socket member, which is contiguous with said cone-like structure, and a hollow ball member, which is contiguous with the medicament interface adapter, wherein said hollow ball member is captively held by said hollow socket member.

43. The drug delivery device of claim 42 further comprising an elongated tubular element extending from said hollow ball member opposite the medicament interface adapter to an end near said animal interface adapter, wherein said medicament interface adapter, said hollow ball member, and said tubular element form a continuous passageway from said medicament interface adapter to said end of said tubular element.

42. The drug delivery device of claim 40, wherein said cone-like structure further comprises at least one annular relatively compliant seal member extending from an inner circumference of said cone-like structure.

43. The drug delivery device of claim 8, wherein said interior reservoir of said medicament dispenser is at least partially filled with medicament, wherein said medicament is selected from the group consisting of ace-inhibitors, acne drugs, alkaloids, amino acid preparations, anabolic preparations, analgesics, anesthetics, antacids, antianginal drugs, anti-anxiety agents, anti-arrhythmias, anti-asthmatics, antibiotics, anti-cholesterolemics, anti-coagulants, anti-convulsants, anti-depressants, anti-diabetic agents, anti-diarrhea preparations, antidotes, anti-emetics, anti-histamines, anti-hypertensive drugs, anti-inflammatory agents, anti-lipid agents, anti-manics, anti-nauseants, anti-nauseants, anti-neoplastics, anti-obesity drugs, anti-parkinsonism agents, anti-psychotics, anti-pyretics, anti-rheumatic agents, anti-spasmodics, anti-stroke agents, anti-thrombotic drugs, anti-thyriod preparations, anti-tumor drugs, anti-tussives, anti-ulcer agents, anti-uricemic drugs, anti-viral drugs, appetite stimulants or suppressants, biological response modifiers, blood modifiers, bone metabolism regulators, cardiovascular agents, central nervous system stimulates, cerebral dilators, cholinesterase inhibitors, contraceptives, coronary dilators, cough suppressants, decongestants, dietary supplements, diuretics, DNA and genetic modifying drugs, dopamine receptor agonists, endometriosis management agents, enzymes, erectile dysfunction therapies, erythropoietic drugs, expectorants, fertility agents, gastrointestinal agents, homeopathic remedies, hormones, hyper- and hypo-glycemic agents, hypercalcemia and hypocalcemia management agents, hypnotics, immunomodulators, immunosuppressives, ion exchange resins, laxatives, migraine preparations, motion sickness treatments, mucolytics, muscle relaxants, neuromuscular drugs, obesity management agents, osteoporosis preparations, oxytocics, parasympatholytics, parasympathomimetics, peripheral vasodilators, prostaglandins, psychotherapeutic agents, psycho-tropics, stimulants, respiratory agents, sedatives, smoking cessation aids, sympatholytics, systemic and non-systemic anti-infective agents, terine relaxants, thyroid and anti-thyroid preparations, tranquilizers, tremor preparations, urinary tract agents, vasoconstrictors, vasodilators, and combinations thereof.

44. The drug delivery device of claim 8, wherein said interior reservoir of said medicament dispenser is at least partially filled with medicament, said medicament comprising an anti-inflammatory agent.

45. The drug delivery device of claim 44, wherein said anti-inflammatory agent is selected from the group consisting of bronchodilators, steroids, ipatropium bromide, and sodium cromoglycate.

46. The drug delivery device of claim 45, wherein said bronchodilators are selected from the group consisting of salmeterol, formoterol, bambuterol, albuterol, terbutaline, pirbuterol, bitolterol, metaproterenol, isoetharine, isoproterenol, fenoterol, and procaterol.

47. The drug delivery device of claim 45, wherein said steroids are selected from the group consisting of budesonide, beclomethasone, fluticasone, and triamcinolone diacetate.

48. The drug delivery device of claim 29, wherein said interior reservoir of said medicament dispenser is at least partially filled with medicament, wherein said medicament is selected from the group consisting of ace-inhibitors, acne drugs, alkaloids, amino acid preparations, anabolic preparations, analgesics, anesthetics, antacids, antianginal drugs, anti-anxiety agents, anti-arrhythmias, anti-asthmatics, antibiotics, anti-cholesterolemics, anti-coagulants, anti-convulsants, anti-depressants, anti-diabetic agents, anti-diarrhea preparations, antidotes, anti-emetics, anti-histamines, anti-hypertensive drugs, anti-inflammatory agents, anti-lipid agents, anti-manics, anti-nauseants, anti-nauseants, anti-neoplastics, anti-obesity drugs, anti-parkinsonism agents, anti-psychotics, anti-pyretics, anti-rheumatic agents, anti-spasmodics, anti-stroke agents, anti-thrombotic drugs, anti-thyriod preparations, anti-tumor drugs, anti-tussives, anti-ulcer agents, anti-uricemic drugs, anti-viral drugs, appetite stimulants or suppressants, biological response modifiers, blood modifiers, bone metabolism regulators, cardiovascular agents, central nervous system stimulates, cerebral dilators, cholinesterase inhibitors, contraceptives, coronary dilators, cough suppressants, decongestants, dietary supplements, diuretics, DNA and genetic modifying drugs, dopamine receptor agonists, endometriosis management agents, enzymes, erectile dysfunction therapies, erythropoietic drugs, expectorants, fertility agents, gastrointestinal agents, homeopathic remedies, hormones, hyper- and hypo-glycemic agents, hypercalcemia and hypocalcemia management agents, hypnotics, immunomodulators, immunosuppressives, ion exchange resins, laxatives, migraine preparations, motion sickness treatments, mucolytics, muscle relaxants, neuromuscular drugs, obesity management agents, osteoporosis preparations, oxytocics, parasympatholytics, parasympathomimetics, peripheral vasodilators, prostaglandins, psychotherapeutic agents, psycho-tropics, stimulants, respiratory agents, sedatives, smoking cessation aids, sympatholytics, systemic and non-systemic anti-infective agents, terine relaxants, thyroid and anti-thyroid preparations, tranquilizers, tremor preparations, urinary tract agents, vasoconstrictors, vasodilators, and combinations thereof.

49. The drug delivery device of claim 29, wherein said interior reservoir of said medicament dispenser is at least partially filled with medicament, said medicament comprising an anti-inflammatory agent.

50. The drug delivery device of claim 49, wherein said anti-inflammatory agent is selected from the group consisting of bronchodilators, steroids, ipatropium bromide, and sodium cromoglycate.

51. The drug delivery device of claim 50, wherein said bronchodilators are selected from the group consisting of salmeterol, formoterol, bambuterol, albuterol, terbutaline, pirbuterol, bitolterol, metaproterenol, isoetharine, isoproterenol, fenoterol, and procaterol.

52. The drug delivery device of claim 50, wherein said steroids are selected from the group consisting of budesonide, beclomethasone, fluticasone, and triamcinolone diacetate.
